(19) United States
(12) Patent Application Publication
(10) Pub. No.: US 2009/0027892 A1
(43) Pub. Date: Jan. 29, 2009

(54) Lamp

(75) Inventors: Matthias Bremerich, Lennestadt (DE); Leonhard Klose, Ludenscheid (DE)

Correspondence Address: K.F. ROSS P.C., 5683 RIVERDALE AVENUE, SUITE 203 BOX 900, BRONX, NY, 10471-0900, US

(73) Assignee: ERCO Leuchten GmbH

(21) Appl. No.: 11/974,517

(22) Filed: Oct. 12, 2007

(30) Foreign Application Priority Data
Jul. 26, 2007 (DE) 202007010500.2
Jul. 26, 2007 (DE) 202007010501.1
Sep. 19, 2007 (DE) 102007044963.3

(51) Int. Cl. F21V 7/09; F21V 7/18

(52) U.S. Cl. 362/297; 362/308; 29/557

(57) ABSTRACT

The invention relates to and discloses a light fixture (10) for illuminating a building surface (15), comprising a dished housing (11) having a light-output opening (24), a light source (12) being provided on the interior (31) of the housing, indirect light (30a, 30b, 30c) starting from the light source passing through a light-output opening only after being reflected on reflector surfaces (21, 22) and direct light (29a, 29b, 29c) starting from the light source passing through without reflection on reflector surfaces, a spread lens (23) being provided that is at the light-output opening and that ensures that the light is spread in order to illuminate the building surface more uniformly, the reflector surfaces each comprising a wall region (22) having a parabolic cross-section and a wall region (21) having an elliptical cross-section.

The invention relates to a light fixture for illuminating a building surface.

In particular, the invention relates to a light fixture for illuminating a building surface, the light fixture evenly illuminating a building surface with the aid of a spread lens.

The invention is based on a light fixture previously publicly used by the applicant and referred to as a lens wallwasher. Such a light fixture is mentioned, for example, on pages 342, 343, and 761 of the catalog “ERCO Product Range, Lighting Controls, Indoor Lighting, Outdoor Lighting, 2006/2007 Issue”. The previously known light fixture comprises a reflector with a parabolic cross-section, the reflector being substantially rotation symmetrical about the longitudinal center axis thereof.

Starting from the light fixture according to the applicant's prior art that became known through its prior public use, it is the object of the invention to further develop the known light fixture such that improved illumination of a building surface is possible.

The invention achieves this object with the characteristics of claim 1.

The inventive light fixture for illuminating a building surface comprises, according to the invention, a dished housing having a light-output opening, a light source being provided in the interior of the housing, indirect light emanating from the light source and passing through the light-output opening only after being reflected on reflector surfaces and direct light starting from the light source passing through the opening without reflection on surfaces of the reflector, a spread lens being provided that is adjacent the light-output opening and that ensures that the light is spread in order to make illumination of the building surface more even, the reflector surfaces each comprising a wall region with a parabolic cross-section and a wall region with an elliptic cross-section.

A building surface as defined by the invention is any surface formed by a building wall, for example a building ceiling, a floor or a side wall, and a partial building surface. Within the meaning of the present patent application, a light fixture for illuminating a building surface can be any indoor or outdoor light fixture. The light fixture according to the invention is preferably a wallwasher. The inventive light fixture can also be used to illuminate objects, such as artwork or merchandise.

The light fixture according to the invention comprises a dished housing. A dished housing is any housing having a substantially arcuate basic shape that is open toward a light-output opening and that elsewhere is substantially closed. This may be a housing that is substantially symmetrically about an axis of rotation. In a preferred embodiment of the invention, the housing is axially elongated, substantially cylindrical, particularly trough-shaped.

A light source is provided in the interior of the housing. Light is emitted by the light source, the light exiting the housing through a light-output opening of the housing. The light-output opening of the housing corresponds, for example, to the light-output opening of the light fixture or is located adjacent thereto. In particular, it may be provided directly adjacent the light-output opening of the light fixture.

The light source is mounted such that both indirect light and direct light can pass through the light-output opening of the housing. Direct light within the meaning of the present patent application is such light that starting from the light source can pass directly through the light-output opening of the housing, without being previously reflected on reflector surfaces. Indirect light of the light source is that light that has been reflected at least once on reflector surfaces before passing through the light-output opening.

A spread lens is mounted between the light source and the light-output opening. A spread lens is understood as any substantially two-dimensional, preferably planar, under certain circumstances also arcuate, body that can ensure spreading of the light. The spread lens spreads both the direct light and the indirect light. Spreading helps produce more uniform illumination of the building surface. In this way, homogeneous distribution of the luminous intensity on the building surface to be illuminated can be achieved.

The spread lens is formed, for example, by a glass plate that is smooth on one of its two faces and comprises cylindrical lenses on the other face. If a light beam impinges upon a cylindrical lens, the beam is spread into a long line as a function of the selected focal length of the cylindrical lens. This line extends at a right angle to the axial direction of the cylindrical lenses.

Similarly, all the light emitted by the light source and impinging upon the spread lens in the form of direct light or indirect light can be considerably spread.

With respect to dimensions, the spread lens is selected such that it covers the entire cross section of the light-output opening. Viewed in the light emission direction, the spread lens may be provided in front of or behind the light-output opening of the housing or at the light-output opening of the housing.

On the inventive light fixture, the reflector surface is formed at least by two differently arcuate wall regions. A first wall region has a parabolic cross-section and a second wall region has an elliptical cross-section. This shape of the reflector surfaces makes it possible to provide the light source directly at the focal points or close to the focal points of both the parabolic wall region and the wall region with the elliptical cross-section. This enables a luminous intensity distribution on the wall to be illuminated, the parabolic shape and the elliptical shape of the corresponding wall region cross-section being selected arbitrarily.

For example, with the inventive light fixture a particularly even light-intensity distribution across the entire vertical height or only along part of the height of the building wall to be illuminated can be achieved. Alternatively, by appropriately orienting the building light fixture relative to the building surface to be illuminated, a particularly homogeneous illumination in a horizontal direction parallel to a floor surface can also be achieved. Finally, a desired light-intensity distribution can also be generated in any arbitrary spatial direction.

The inventive arrangement and combination of wall regions having parabolic and elliptical cross-sections with one another enable in particular also an asymmetrical light-intensity distribution. Particularly when providing the building light fixture relatively close to the wall, the illumination of regions of the building surface to be illuminated that are remote from the light fixture can be achieved. As a result, light-intensity distributions and particularly uniform, homogeneous illuminations of building surfaces can be achieved, which were not possible with the light fixtures according to the prior art.

According to an advantageous embodiment of the invention, the housing is trough-shaped. This enables the use of fluorescent tube lamps, where also a plurality of lamps may be accommodated longitudinally behind one another in a common housing. It is also possible to provide a plurality of base bodies longitudinally next to one another or to provide a plurality of light fixtures longitudinally in a row. In this way, particularly uniform illumination of a building surface across a nearly arbitrary longitudinal extension can be achieved.

Even when providing only a single light fixture having a trough-shaped housing, light-intensity distribution that extends in the longitudinal direction can be achieved on the building surface to be illuminated. Finally, the trough-shaped housing enables a simplified design.

According to a further advantageous embodiment of the invention, the light source is axially elongated. This enables the use of conventional, bright lamps from the prior art.

According to a further advantageous embodiment of the invention, the spread lens ensures the spreading of the light in the axial direction. This, in conjunction with a trough-shaped housing, enables particularly uniform illumination of the building surface across a building surface that extends longitudinally.

According to a further advantageous embodiment of the invention, the housing and/or the wall regions are cylindrical. A cylindrical shape within the meaning of the present patent application shall mean that the housing and/or the wall regions have a constant cross-section along the axial dimension of the housing. This enables a simplified design since in particular elongated profiles can be used as components for the design of the light fixture.

In this context, it is noted that the reflector surfaces can be formed directly by wall regions of the housing. The reflector surfaces, however, may also be provided inside the housing. In the latter variant, the housing can also be formed directly by a housing of the light fixture.

According to a further advantageous embodiment of the invention, the spread lens comprises a plurality of ribs extending transversely to the axial extension to form cylindrical lenses. In this embodiment of the invention, the cylindrical lenses are preferably perpendicular to the axial extension of the housing. While the wall regions, particularly the parabolic wall region and the elliptical wall region, extend along the axial direction and thus ensure the desired light-intensity distribution, particularly an extremely homogeneous illumination of the building surface, in a direction transversely to the axial direction, the light-intensity distribution can be spread in the axial direction by arraying the cylindrical lenses transversely to the axial direction. This enables a uniform illumination of the building surface across a very large area.

According to a further advantageous embodiment of the invention, a metal halide lamp, particularly an HID lamp or a low-voltage halogen incandescent lamp, is provided. The use of such bright light sources enables particularly high luminous intensity levels to be achieved on the building surface to be illuminated. In this way, even quite large building surface regions, which under certain circumstances may even be located relatively far from the light fixture, can be satisfactorily illuminated using a single light fixture.

The light source is preferably a fluorescent tube light source that radiates in a 360° range about the center longitudinal axis thereof.

According to a further advantageous embodiment of the invention, the wall regions are made of metal, particularly of aluminum. This enables the use of lamps generating a great deal of heat, such as metal halide lamps or low-voltage halogen incandescent lamps. In addition, the design of a light fixture according to the invention can be simplified in this way.

According to a further embodiment of the invention, the light fixture is a wallwasher. In this way, an inventive light fixture can be provided relatively close to the building wall to be illuminated and a homogeneous illumination of the desired region of the building wall becomes possible.

According to a further embodiment of the invention, the light fixture is an in-ground light fixture. When using the special parabolic and elliptical wall regions, the light fixture according to the invention can homogeneously illuminate building surface regions that are remote from the light fixture and close to the light fixture.

According to a further advantageous embodiment of the invention, the light source is provided at the focal point or close to the focal point of the elliptical wall region and in the focal point or close to the focal point of the parabolic wall region. In this way, the light-intensity distribution on the building surface to be illuminated can be predicted with relative ease, conventional, known lighting technology principles being usable. In particular, it can be taken into consideration that the light source provided at the focal point of the elliptical wall region emits indirect light, these indirect light being bundled in a second focal point. With an appropriate geometric shape of the elliptical wall region and light-output opening of the light fixture, optionally also by using a glass cover plate, the light source is designed such that the second focal point is located outside the housing, in other words, in the light radiation direction behind the spread lens and/or adjacent of the light-output opening of the light fixture, preferably near a cover glass.

If the light source is provided in the focal point or close to the focal point of the parabolic wall region, the indirect light, which was emitted by the light source and reflected on the parabolic wall region, leaves the housing along a parallel main radiation direction. The parabolic wall region is oriented relative to the light source such that preferably a region of the building surface to be illuminated that is remote from the light fixture is illuminated with this indirect light. The wall region having an elliptical cross-section is provided such that the indirect light reflected by this wall region preferably illuminates a region of the building surface to be illuminated that is located close to the light fixture.

According to a further advantageous embodiment of the invention, the light fixture uniformly illuminates the building surface. In this way, the desired illumination effect can be achieved in a particularly advantageous manner.

According to a further advantageous embodiment of the invention, the elliptical wall region extends along an angle of between 90° and 270° around the light source. The elliptical wall region preferably extends along an angle of approximately 205° around the light source. As a result, the elliptical wall region covers a larger angle than the angle along which the parabolic wall region extends.

Relative to the basic shape of the reflector with the two wall regions and the light-output opening of the housing, the light source can be oriented such that, for example, an aperture angle of approximately 70° relative to the focal point or the location of the light source is obtained, so that the elliptical wall region and the parabolic wall region together cover an angle of approximately 270°.

According to a further advantageous embodiment of the invention, the parabolic wall region extends substantially along an angle of between 20° and 100°, preferably along an angle of between 30° and 90°, more advantageously along an angle of approximately 70°.

According to a further advantageous embodiment of the invention, the spread lens is oriented substantially transversely to a main illumination direction of the light fixture. In particular, the spread lens is oriented at an angle to the wall to be illuminated.

The light fixture furthermore advantageously comprises a cover glass, particularly when it is an in-ground light fixture. The spread lens can then be provided at an angle to the cover glass, particularly at an angle between 20° and 60°, further preferred at an angle of approximately 45°.

The elliptical wall region and the parabolic wall region may be connected to an intermediate element, which may be flat, for example in order to directly attach the two wall regions to one another and to compensate for variances in their radial distances relative to the light source.

The invention furthermore relates to a light fixture for illuminating building surfaces according to claim 20.

The invention is again based on the light fixture described at the beginning, which is known by the prior public use by the applicant.

Also this invention is based on the object of further developing the light fixture according to the applicant's prior art, which became known by prior public use, such that improved illumination of a building surface becomes possible.

The invention achieves this object with the characteristics of claim 20.

The light fixture according to the invention serves to illuminate building surfaces, particularly for the especially uniform and homogeneous illumination of large portions of building surfaces. Within the meaning of the formulation of claim 20 regarding the building surface, the formulation provided above can be used.

The light fixture comprises a reflector element that is substantially dished. It is an arcuate, hollow reflector element that is substantially shaped like a cup. It has in its interior a reflector surface. The reflector element is preferably made of metal, with press-formed aluminum being more preferred.

The reflector element extends along a center longitudinal axis from an apex region to a light-output opening. The element widens along the center longitudinal axis, in other words, the diameter of the reflector element increases as spacing from the apex region increases.

The reflector element preferably has a substantially parabolic cross-section. Furthermore, the reflector element is preferably cut along a plane that is oriented at an angle to the center longitudinal axis of the reflector element.

The apex region is the region of the reflector element most widely spaced from the light-output opening. In the apex region of the reflector element preferably an aperture or opening for a lamp is provided. Furthermore, the reflector element is preferably attached to a housing of the lamp near the apex and/or near the free edge region.

In the interior of the reflector element at least one lamp can be provided. Conventional lamps, particularly metal halide lamps, such as HID lamps, can be used as the lamp.

The light source is preferably a punctiform light source.

The light-output opening of the reflector element is the opening through which light must pass in order to reach the building surface to be illuminated. While in the case of a completely rotation-symmetrical reflector element the light-output opening has a circular shape, the light-output opening of the reflector element in the inventive light fixture is surrounded by an oval edge due to a cut plane that is angled obliquely to the center longitudinal axis of the reflector element.

Both direct and indirect light can pass through the light-output opening. Indirect light refers to all the light rays that, starting from the light source, only pass through the light-output opening after being reflected inside the reflector. Direct light is all the light rays that can pass through the light-output opening without being reflected in the interior of the reflector. The building surface to be illuminated is therefore preferably illuminated by direct and indirect light.

When using a lamp, that is a light-emitting means that in the main radiation direction of the lamp, namely in a direction along the center longitudinal axis of the reflector element, carries an opaque cap element, it is possible under certain circumstances that no direct light pass through the light-output opening. When using lighting means that can radiate also in the direction of the center longitudinal axis of the reflector element, advantageously also direct light impinges upon the spread lens.

A spread lens is provided near of the light-output opening, preferably directly in the light-output opening of the reflector element. In accordance with the above explanations provided for claim 1 and the claims referring back to it, a spread lens is a two-dimensional, particularly flat element that is designed to be translucent and comprises a plurality of preferably cylindrical lenses. The spread lens serves to spread light along a single preferred direction. The spreading of the light helps produce a more uniform illumination of the building surface. In the simplest case, a plurality of rib-shaped elongated cylindrical lenses are provided on at least one face of the spread lens, which is made for example of glass.

A spread lens as defined by the present patent application can be made of clear or slightly matte-finished glass, for example sheet glass. The cylindrical lenses can be provided on one or both faces of the spread lens. Cylindrical lenses can be formed by convex curvatures or curved surfaces with a concave cross-section. The cylindrical lenses are preferably continuous and extend from one edge of the lens plate to the opposite edge of the spread lens, the cylindrical lenses being formed by a plurality of microlenses that likewise ensure spreading of the light.

Inside the reflector element a plurality of segments are provided, the segments each comprising a surface arcuate toward the interior of the reflector element. By providing a plurality of individual segments, it is possible to arbitrarily design the light radiation characteristics of the reflector element and in this way achieve any desired illumination characteristic. Particularly when using cylindrical segments it is possible to adjust the light distribution along a first direction in the desired manner. By using a spread lens, additional spreading and uniformity can be achieved along a second direction perpendicular to the first direction.

The invention recognizes that, in order to achieve uniform illumination of a building surface, a reflector element can be shaped to achieve a certain lighting characteristic along a first direction, regardless of the subsequent design and positioning of a spread lens. By optimizing the inner surface of the reflector element, that is the active reflection surface, the light radiation characteristic along the first direction can be influenced in the desired manner.

For example, when configuring the inventive light fixture according to claim 20 as a recessed light fixture or as a spotlight provided at the building ceiling, it may be desirable to uniformly illuminate a vertical wall. In order to also evenly illuminate particularly low regions, that is regions of the vertical wall close to the floor, or even emphasize these regions, a different radiation characteristic of the light fixture may be desired than when particularly high regions, that is regions of the vertical building surface close to the building ceiling, are supposed to be illuminated. Both applications can be achieved by appropriately configuring the segments. It is also possible to illuminate very high, vertical building walls or surfaces across large areas close to the light fixture with the inventive light fixture.

Due to the provision of a plurality of segments, the inner surface of the reflector element can be designed in many ways. For example, a first angularly extending region or partial region of the reflector element can imitate the light radiation characteristics of a reflector having a parabolic cross-section, and a different angular portion or another partial region of the interior of the reflector element can imitate the light radiation characteristic of a different reflector, for example a reflector having an elliptical cross-section. In this way, the building surface can be illuminated in an optimized, particularly homogeneous manner.

The inventive combination of a spread lens with a reflector comprising segments furthermore allows particularly dense luminance to be achieved outside the spread lens or near the light-output opening of the light fixture. This reduces undesirable glare effects for the observer.

According to an advantageous embodiment of the invention, the reflector element is made of metal. This enables the use of lamps radiating high heat energy and a simple design.

According to a further advantageous embodiment of the invention, the reflector element is made of press-formed aluminum. As a result, conventional manufacturing methods and materials can be employed.

According to a further advantageous embodiment of the invention, the reflector element comprises a housing that is rotation-symmetrical about the center longitudinal axis thereof with respect to the basic shape, the housing being truncated, sawed off or cut in another manner at the light-output opening along a plane at an angle to the center longitudinal axis. It is known from the prior art to produce reflector elements having a substantially rotation-symmetrical shape by deforming circular aluminum blanks in a press. In this respect, reference is made by way of example to the post-published German patent applications DE 10 2007 035 396 and DE 10 2007 035 528, which are both by the applicant, and the content of which is hereby included by reference in the present patent application, also for the purpose of referring to individual or several characteristics.

By producing a reflector element having a rotation-symmetrical housing, the manufacture of the reflector element can be kept relatively simple. Cutting the housing at the light-output opening thereof along a plane that extends at an angle to the center longitudinal axis crates a light fixture with a very small installation depth, that is a compact design. In order to achieve the desired lighting characteristic, unneeded reflector sections can be severed and discarded.

A reflector that is made according to this advantageous embodiment of the invention allows the segments, which comprise different, individually shaped reflection surfaces, to be provided in any distribution along the interior of the reflector element. The segments may be rotation asymmetrical, while the housing is substantially rotation symmetrical about its center longitudinal axis. While the outer surface of the reflector element is rotation symmetrical prior to severing the reflector element along the cut plane, the reflective inner surface is preferably provided with differently rotation-asymmetrical arcuate segments.

According to a further advantageous embodiment of the invention, the spread lens is mounted on the cut plane. As a result, a particularly compact shape of the light fixture becomes possible.

According to a further advantageous embodiment of the invention, at least several of the segments are each formed by a section of a cylinder, particularly a circular cylindrical body. The use of cylindrical segments advantageously enables the desired radiation characteristic of the light fixture to be achieved along a first direction. All segments in the interior of the reflector element are preferably formed by cylindrical bodies, particularly circular cylindrical bodies.

The center longitudinal axis of the cylinder, referred to as the cylinder axis, is preferably oriented substantially parallel to the center longitudinal axis of the reflector or angled relative to the same at an angle of less than 45°. The cylinder axis is the axis of a cylindrical segment, which is the center longitudinal axis of the corresponding circular cylinder that provides the cylinder surface. The angles of the cylinder axes may vary with spacing of the cylinder from the apex region of the reflector. By varying the inclinations of the center lines of the cylinders, the desired light radiation characteristic can be implemented in a particularly optimized manner.

Furthermore, tangents are formed on the outer surface of the reflector in a connecting region of a cylindrical segment to the reflector. Between the respective tangent and cylinder axis of the associated segment, an angle of deviation is located. This angle of deviation can advantageously vary with the varying distance of the segment from the apex region. For this purpose, reference is made to the above-mentioned German patent application DE 10 2007 035 396 by applicant, which describes in detail the advantages of segments shaped this way, and the content of which is hereby also included by reference in the present patent application, also for the purpose of referring to individual characteristics.

According to a further advantageous embodiment of the invention, the angles of the cylinder axes of the cylindrical segments, particularly along an angle of circumference, are advantageously selected such that the light rays impinging upon the cylindrical segments intersect at a focal point when using a punctiform light source. This enables, for example, the imitation of a reflector having an elliptical cross-section, even if the reflector element uses a housing having a shape with a parabolic cross-section. In this way, elliptical reflectors can be imitated, while at the same time making light fixtures with very small installation depths.

According to a further advantageous embodiment of the invention, the focal point is located outside the light-output opening of the reflector element. Furthermore, the focal point is advantageously located close to the light-output opening of the light fixture. This enables a particularly optimized light distribution and a particularly compact light fixture.

According to a further advantageous embodiment of the invention, the cylinder axes of a plurality of cylinders, particularly of a partial region of the interior of the reflector element, with the region being explained in more detail hereinafter, having the same distances to the apex region of the reflector form the same angles with the center longitudinal axis of the reflector element. This enables particularly uniform illumination of the building surface.

According to a further advantageous embodiment of the invention, the inner surface of the reflector element is provided with segments around its entire circumference. This enables a particularly optimized adjustment of the light fixture to the desired radiation characteristics.

According to a further advantageous embodiment of the invention, the inner surface of the reflector element is divided into at least two partial regions. Segments of different types, for example segments of a first type and segments of a second type, can be provided in different partial regions. Segments of a first type may imitate the reflection behavior of a reflector having a parabolic cross-section, and segments of a second type may imitate the reflection behavior of a reflector having an elliptical cross-section. In the different partial regions, it is also possible that segments of different sizes, elongated differently in the axial direction, and differently arcuate or different bent segments may be provided. It is also possible that the number of columns and the number of rows of the segments vary in the different partial regions. A first partial region preferably extends over an angle of 180° and a second partial region over an angle of 180°. In a different embodiment of the invention, more than two partial regions having different angles of circumference may be provided.

The segments may be arrayed in circular rows about the center longitudinal axis of the reflector and along columns extending transversely of the rows.

In one of the two partial regions, the number of rows of segments is preferably higher, preferably twice as high, as the number of rows of segments in the other partial region. Furthermore, in the partial region with the higher number of rows, the segments of two adjoining segments in the axial direction, respectively, are preferably provided offset relative to one another angularly such that a imbricated structure is obtained.

Furthermore, due to a severing of the produced reflector element along a cut plane obliquely to the center longitudinal axis of the reflector element, the number of segments in a column preferably varies as a function of the angular dimension of the column.

According to a further advantageous embodiment of the invention, the first partial region and the second partial region are separated by a boundary plane. In the first partial region preferably segments are provided that primarily imitate a reflection behavior of a reflector having a parabolic cross-section, and in the second partial region segments are provided that primarily imitate a reflection behavior of a reflector having an elliptical cross-section.

The boundary plane and the cut plane meet in a straight line. This straight line is oriented perpendicular to the center longitudinal axis of the reflector element.

The largest cross-sectional area of the reflector element is on a section through the reflector element along the center longitudinal axis thereof, the section being made perpendicular to the boundary plane. The largest cross-sectional area of the reflector element is hence on a cross section of the reflector element, comprising the segment farthest remote from the apex region and the segment oriented 180° opposite thereof at the free edge of the reflector element.

When viewing a largest cross-sectional area of the reflector element, a plurality of segments of a first type are provided on the first side of the center longitudinal axis of the reflector element and a plurality of segments of the second type are provided on the other, opposite side of the center longitudinal axis of the reflector element. This observation illustrates that the reflector element comprises two essential, characteristic regions with different features regarding the light beam and/or reflection characteristic. The region of the reflector element that is remote from the building surface to be illuminated comprises a plurality of segments that imitate the reflector behavior of an elliptical reflector, and the segments of the reflector element provided on the side of the center longitudinal axis that is close to the building surface to be reflected imitate the reflection behavior of a reflector having a parabolic cross-section.

According to a further advantageous embodiment of the invention, when viewing a cross-sectional area that is oriented perpendicular to the largest cross-sectional area, a symmetrical reflector element relative to the center longitudinal axis is apparent. The observation in this embodiment of the invention is thus made along a plane that extends parallel to the boundary plane. When observing such cross-sectional areas, the reflector element appears to be completely symmetrical. This embodiment is particularly advantageous in order to achieve especially uniform illumination of the building surface.

According to a further advantageous embodiment of the invention, the spread lens ensures the spreading of the light in a direction transversely to the largest cross-sectional area. Spreading is thus performed in a direction along the boundary plane.

The spread lens comprises a plurality of cylindrical lenses, for example formed by a plurality of ribs extending transversely to the boundary plane, in other words, along a direction parallel to the largest cross-sectional area. The cylindrical lenses preferably extend in a direction along the cut plane.

Furthermore, the light fixture is advantageously a wallwasher.

This enables a particularly uniform illumination of the wall.

Furthermore, the light fixture is advantageously a recessed light fixture or as a spotlight to be installed on the ceiling. This enables a uniform illumination even of regions on the vertical wall close to the ceiling.

According to a further advantageous embodiment of the invention, a partial region of the reflector for imitating a light distribution of a parabolic reflector is oriented relative to the light source such that the light reflected thereon primarily illuminate a region of the light fixture remote from the light fixture. Similarly, advantageously the regions of the reflector imitating the light distribution of a reflector having an elliptical cross-section are oriented such relative to the light source that the light beam portions reflected therein primarily illuminate a region of the building surface close to the light fixture. In this way, even very high vertical building surfaces can be illuminated.

The invention furthermore relates to a method for producing a reflector element made of a starting material workpiece according to claim 59.

Methods for producing reflector elements that are rotation symmetrical about the center longitudinal axis thereof are known.

It is the object of the invention to further develop a known method for producing a reflector element such that a reflector element can be produced that allows the development of light fixtures in compact designs.

The invention achieves this object with the characteristics of claim 59.

Compared to known methods for producing a reflector element, according to the invention a section of the reflector element is cut off along a separation plane. The separation plane extends at an angle to a center longitudinal axis of the reflector element. At an angle shall mean that severing occurs along an acute angle to the center longitudinal plane, preferably along an angle ranging between 30° and 50°. Furthermore, with respect to the angle of the plane, the inclination of the separation or cut plane preferably corresponds to the desired shielding angle of the light fixture in the installed state to be provided by the dark light reflector.

The invention furthermore relates to a light fixture according to claim 60.

It is the object of the present invention to further develop a known light fixture by the applicant, the light fixture having been described above and known by prior public use, such that greater variability of the illumination of building surfaces is possible.

The invention achieves this object with the characteristics of claim 60.

The principle of the invention is essentially to provide a first reflector element for the light fixture, a plurality of segments comprising surfaces that are arcuate inwardly being provided in the interior of the element. In addition, a second reflector element is provided that can replace the first reflector element. The second reflector element has outer dimensions that are identical or very similar to those of the first reflector element. This means that the basic shape of the second reflector element corresponds to the basic shape of the first reflector element. Also the second reflector element is cut or truncated obliquely or at an angle to the center longitudinal axis, or comprises an oval opening, the edge of which is oriented along a plane that is oriented at an angle to the center longitudinal axis of the reflector element. Also the oval light-output opening has identical dimensions in both reflector elements, so that the same spread lens can be used for the first or second reflector element.

Compared to the first reflector element, however, the second reflector element is provided with a different number or type or configuration or curvature of segments. For example, the radii of curvature of the segments can be oriented differently, or a different orientation of the cylinder axes of cylindrical segments may be provided. The type or configuration of the segments is varied as desired in order to achieve a defined light radiation characteristic. This light radiation characteristic that is produced by the second reflector element, differs from the light radiation characteristic that the first reflector element can produce using the same light source.

While with the aid of the spread lens, for example, uniform illumination of the wall across a large vertical height can be produced with the first reflector element, when replacing the first reflector element with the second reflector element, for example, a focus area, in other words, a lighting focus area, of the building surface to be illuminated in a certain location can be achieved.

The second reflector element has the same dimensions as the first reflector element, so that it can be installed and attached in the existing light fixture housing with the same fastening means and using the same spread lens. This enables a modular light fixture design and the use of a second reflector element instead of an existing first reflector element provided at the point of use. By replacing a first reflector element with a second reflector element, a desired, completely different light radiation characteristic can be produced.

Further advantages of the invention are disclosed in the dependent claims, which have not been cited, as well as the description provided hereinafter by way of example of the embodiment illustrated in the drawings, wherein:

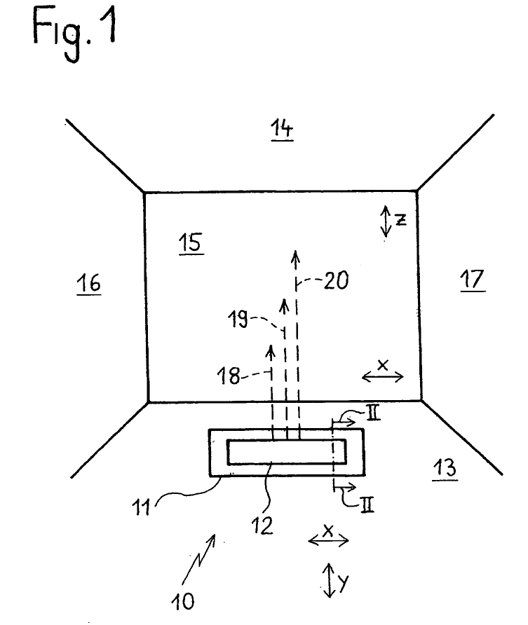

FIG. 1 is a first example of the light fixture according to the invention in a very schematic illustration, comprising a trough-shaped housing that is provided at the bottom and illuminates a housing wall,

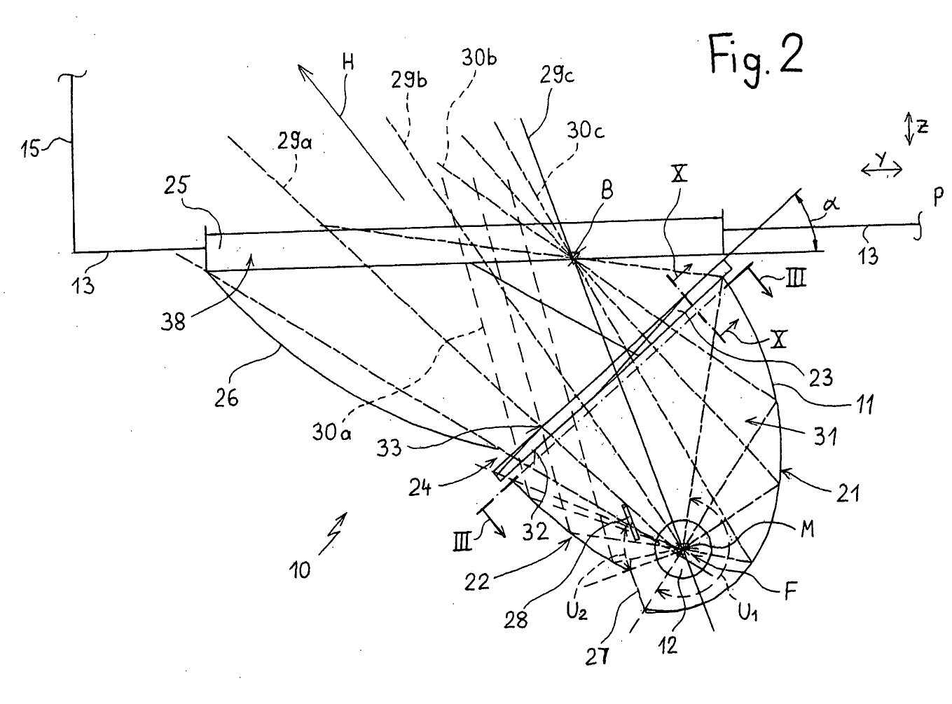

FIG. 2 is a schematic cross-sectional end view of the light fixture according to FIG. 1, approximately along section line II-II of FIG. 1,

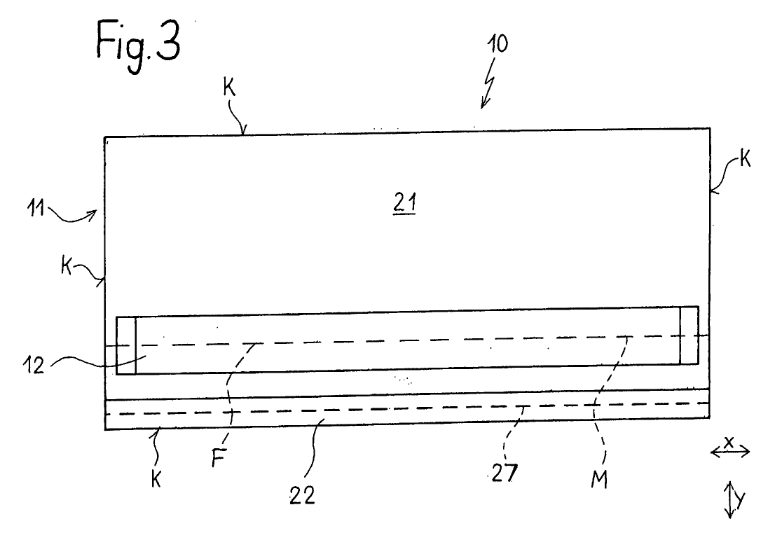

FIG. 3 is a schematic illustration of the light fixture according to FIG. 2, illustrating the housing and the shape of the light source, approximately along section line III-III of FIG. 2,

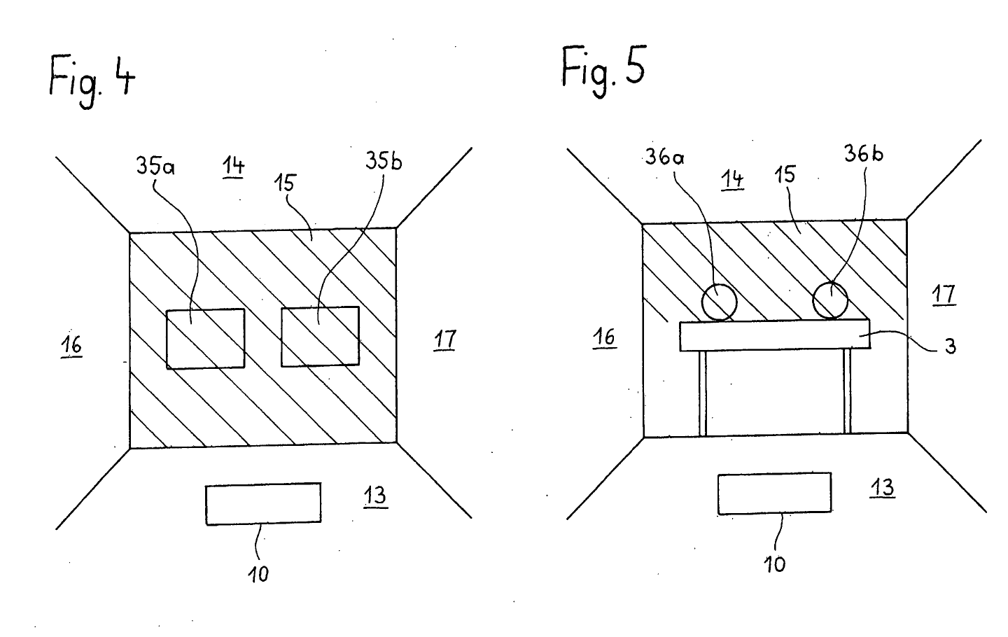

FIG. 4 is a schematic view, in a view like FIG. 1, of a building surface to be illuminated in a first illumination situation,

FIG. 5 is the depiction, in a view like FIG. 4, of a second, different illumination situation,

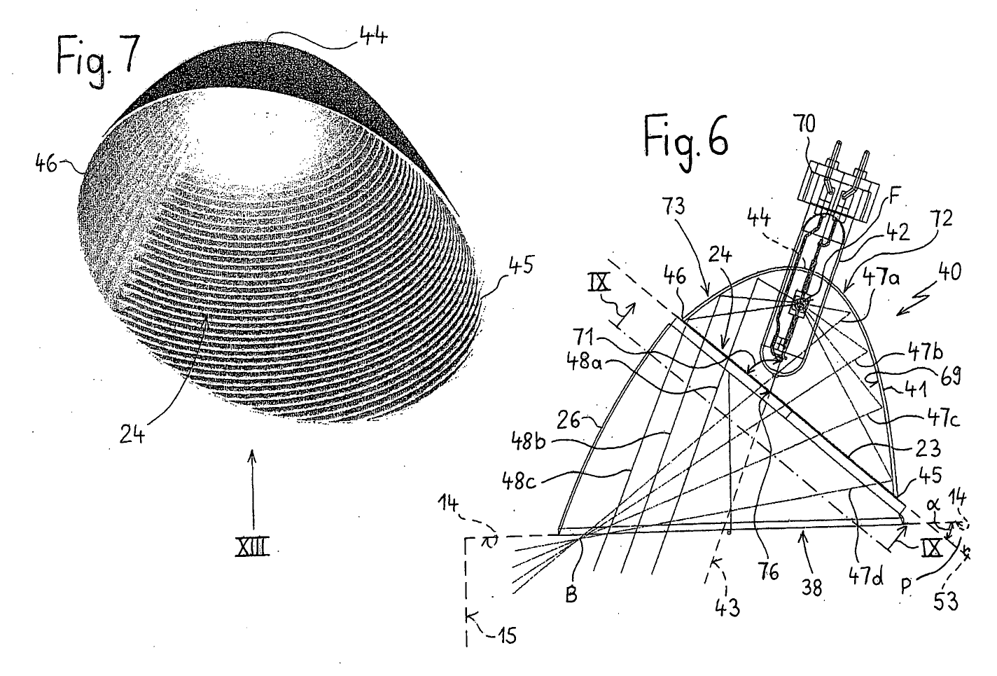

FIG. 6 is a schematic illustration, similar to the view of FIG. 2, of a further example of a light fixture according to the invention a recessed light fixture,

FIG. 7 is the reflector element of the light fixture according to FIG. 6 in a perspective view, the element being provided internally with a plurality of segments,

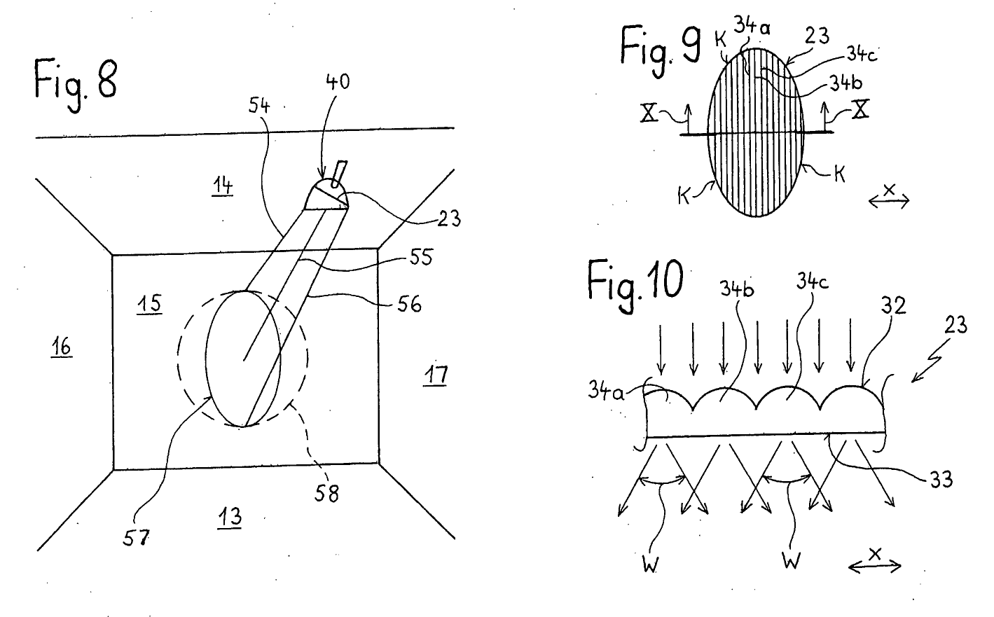

FIG. 8 is a schematic view like FIG. 1, an installation situation for illuminating a building surface, the light fixture according to FIG. 2 being mounted on the ceiling,

FIG. 9 is a separate view of a spread lens that is used for the light fixture according to FIG. 6, in a schematic illustration not to scale, approximately along the on the plane line IX-IX of FIG. 6, a dark-light reflector section of the light fixture according to FIG. 6 having been left out for sake of clarity,

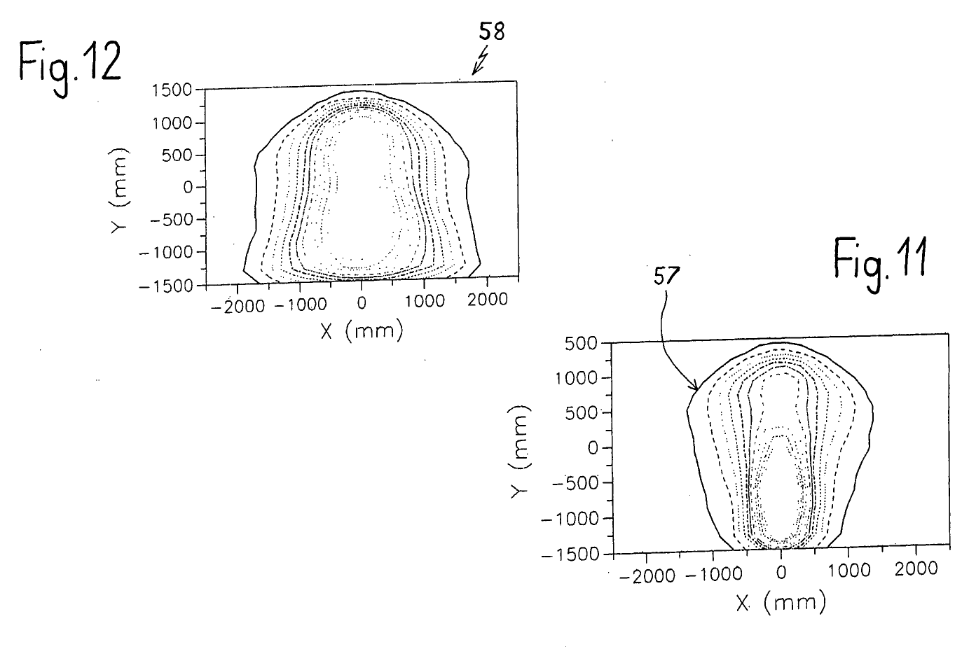

FIG. 10 is the lens plate in a schematic, partially sectional view approximately along section line X-X of FIG. 9,

FIG. 11 is a diagram of the light-intensity distribution obtained when using a light fixture according to FIG. 6 in an installation situation according to FIG. 8 on a wall 15 to be illuminated if the spread lens provided in the light fixture according to FIG. 6 is removed,

FIG. 12 is an illustration according to FIG. 11 of the light-intensity distribution on the wall 15 to be illuminated when using a light fixture according to FIG. 6 with a spread lens,

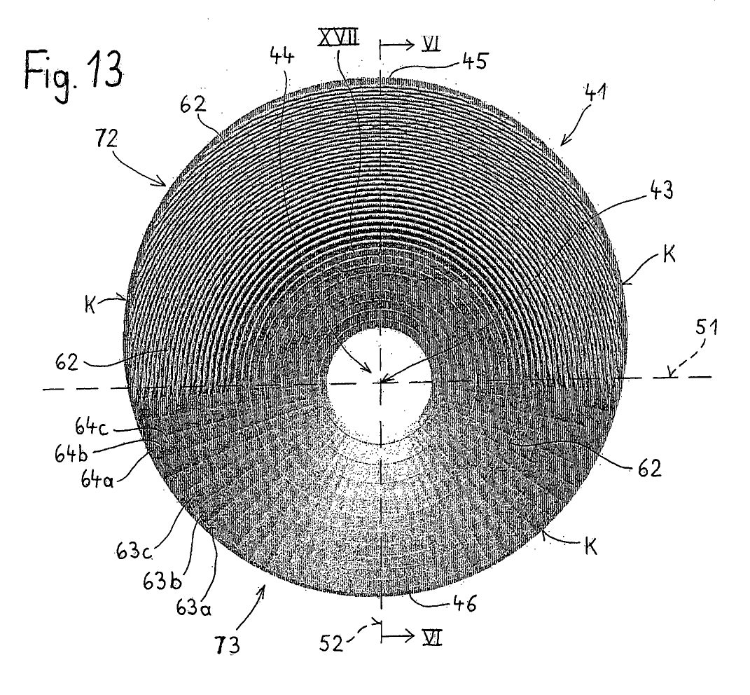

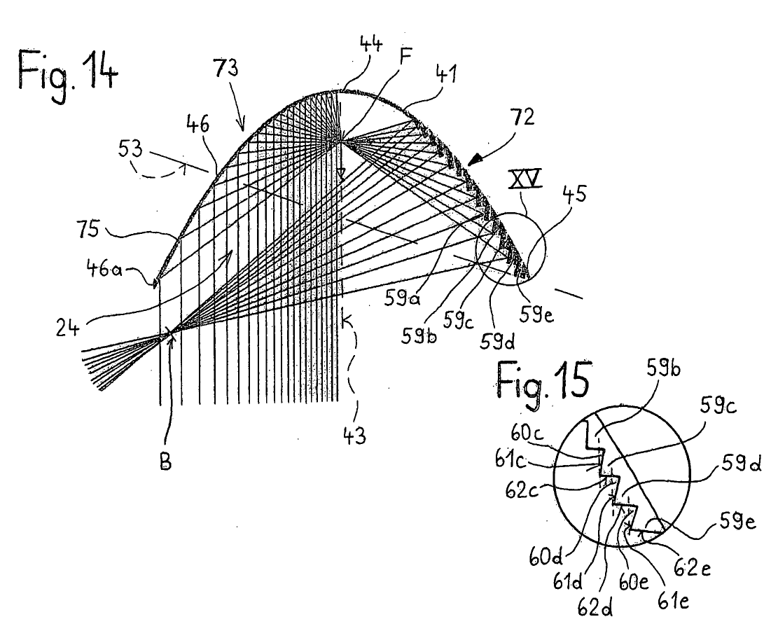

FIG. 13 is a view of the interior of the reflector element according to FIG. 7, approximately according to arrow XIII of FIG. 7,

FIG. 14 is a schematic cross-sectional view of the reflector element according to FIG. 13, approximately along section plane VI-VI, the illustration according to FIG. 14 showing the reflector element immediately after manufacture, before the cutting or severing step, whereas the reflector element according to FIG. 13 is the reflector element after completion, that is after the severing step and after cutting off a piece 75,

FIG. 15 is an enlarged detailed view of an edge region of the reflector element from FIG. 14 according to the circle XV of FIG. 14,

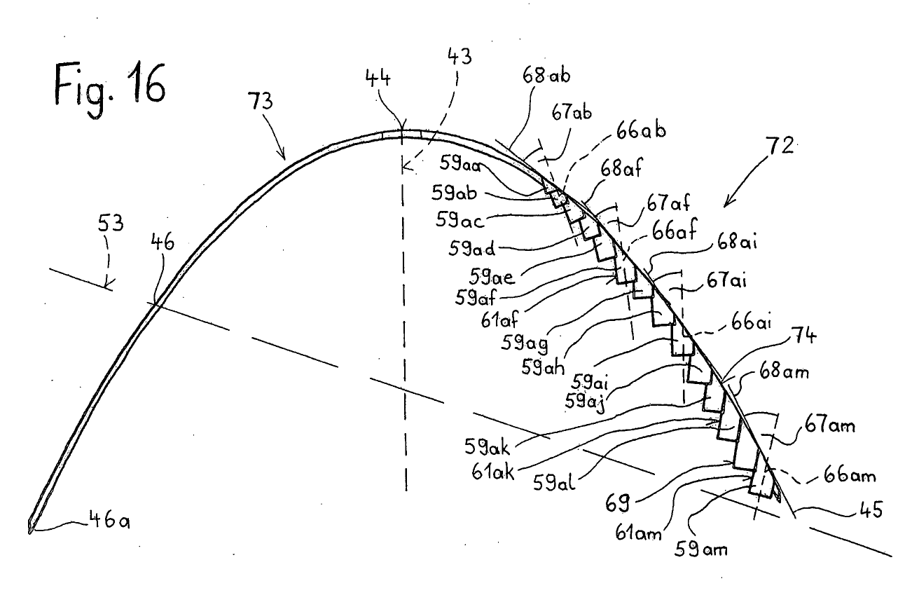

FIG. 16 is an illustration comparable to FIG. 14 of the reflector element in a schematic view, showing the orientations of the cylinder axes, and

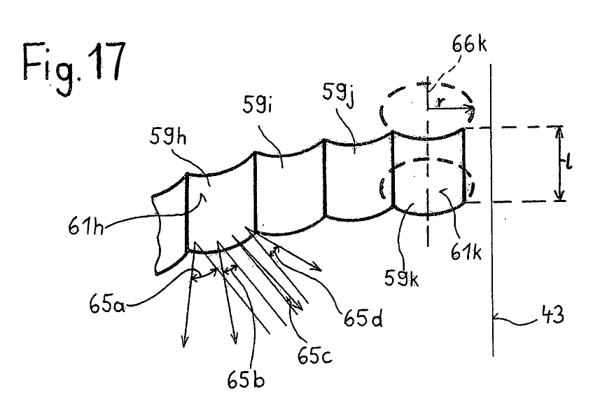

FIG. 17 is an enlarge illustration of a region of the inner surface of the reflector element comprising segments as shown by circle XVIII of FIG. 13.

A first embodiment of the inventive light fixture is indicated overall in the figures with reference numeral 10. With respect to the description of the figures below, it should be noted that insofar as different parts or elements are indicated in the figures, they are identified with the same reference numerals, in part by adding lower-case letters. This also applies to different exemplary embodiments of the invention.

According to FIG. 1, the inventive light fixture 10 is provided with a housing 11 and a light source 12 and serving as an in-ground light fixture. For this purpose, it is installed in the floor 13 of a building room or an exterior space and mounted substantially flush with the upper surface of the floor 13, as will be apparent below from FIG. 2.

In the example according to FIGS. 1 to 3, the light fixture is an axially elongated light fixture comprising a substantially trough-shaped housing 11.

FIG. 1 shows how the light fixture is installed in the floor in the installation situation according to FIG. 1 and serves to illuminate the building wall 15. Arrows 18, 19, and 20 are intended to illustrate that different vertical surface regions of the building surface 15 can be illuminated. Alternatively, the light fixture 10 however can also be ceiling-mounted, that is to say it can be installed in or on the ceiling wall 14, and uniformly illuminate the building surface 15. Finally, it is also possible to mount the building light fixture 10 on the side wall 16 or 17 in order to illuminate the building surface 15. It is likewise conceivable that the light fixture 10 serving as an in-ground light fixture in an installation situation according to FIG. 1 does not illuminate the building wall 15, but the building wall 16 or the building wall 17.

In FIG. 1, the spatial coordinate system is illustrated by the arrows x, y, and z. The double arrow x indicates the axial extension of the light fixture and the double arrow z a direction transverse to the axial extension, specifically the vertical height. The double arrow y that is only indicated in FIG. 1 with reference to the floor surface 13, describes a further lateral extension to the axial direction x, specifically the spatial depth.

It is best apparent from FIG. 2 that the housing 11 is substantially dished. The light source 12 is provided on the interior 31 of the housing 11. It is an axially elongated light source, for example an axially elongated HID lamp. The housing 11 comprises a wall region 21 with an elliptical cross-section. The elliptical wall region 21 is associated with a focal point F, the light source 12 being oriented relative to the elliptical wall region 21 such that the center longitudinal axis M thereof (FIG. 3) lies on the focal point axis F. The rays emitted by the light source 12 and reflected on the elliptical reflector surface 21 therefore meet at a second focal point B that is located at a cover glass 25 of the light fixture. The indicated light beam 29c, which is direct light, likewise extends through the second focal point B

The housing 11 furthermore comprises a second reflector wall region 22 that has a parabolic cross-section. The wall region 22 is oriented such that the focal point of the parabola coincides with the focal point F of the elliptical wall region 21.

In an embodiment of the invention that is not illustrated, the wall region of the reflector having a parabolic cross-section is oriented such that the focal point of the parabolic wall region is provided at a distance from the focal point of the elliptical wall region 21. The light source can then be provided either on the focal point of the elliptical wall region or on the focal point of the parabolic wall region or between the two focal points or in the vicinity of the two focal points.

Starting from the light source 12, direct light, indicated by the beams 29a, 29b, and 29c, and indirect light, indicated by the beams 30a, 30b, and 30c, reach a spread lens 23. The indirect light, which starting from the light source 12 is reflected on the parabolic wall region 22 before impinging upon the spread lens 23, all reaches the lens plate along a parallel main radiation direction H, illustrated by the light beam 30a.

The spread lens can be, for example, made of clear glass or slightly matte-finished glass that is provided with cylindrical lenses. In the example according to FIG. 2, the lens plate has a substantially rectangular basic shape that corresponds approximately to a shape K of the housing 11 according to FIG. 3. The spread lens can be embossed glass or sheet glass.

The cross-section of the lens plate is indicated schematically in FIG. 10 in accordance with plane X-X of FIG. 2. The spread lens 23 can accordingly comprise an inner face 32 and an outer face 33. On the inner face 32 of the lens plate 23, a plurality of cylindrical lenses 34a, 34b, and 34c are provided. A beam of rays, which according to FIG. 10 is illustrated as being parallel, is widened under a divergence angle w as a function of the focal length of the cylindrical lenses.

Comparable spreading of course also occurs when the light beam occurring on the inner face 32 of the spread lens does not impinge entirely parallel, as is the case in the example of the light fixture according to FIGS. 1 to 3, but instead arriving from different directions.

The cylindrical lenses 34a, 34b, 34c have a constant cross-section along a direction transverse to the view plane of FIG. 10. Each cylindrical lens 34a, 34b, 34c has an elongated shape. The longitudinal extension of the cylindrical lenses is thus oriented transversely to the axial extension x of the trough-shaped housing 11 and transversely to the axial longitudinal extension of the light source 12.

The cylindrical lenses may have an axial dimension that corresponds to the axial dimension of the spread lens 23. In an alternative embodiment of a spread lens 23, which is not shown, the cylindrical lenses can also be formed by axially short sections of cylindrical lenses.

While the lenses in the example according to FIG. 10 are convex lenses on the inner face 32, alternatively also concave lenses can be used, achieving the same lighting effect.

It is apparent from FIG. 2 that the provision of the elliptical wall region 21 combined with the provision of the parabolic wall region 22 on the vertical wall 15 generates a light-intensity distribution that illuminates the building surface 15 in the desired manner. The beam of rays reflected by the parabolic reflector surface 22 and radiating parallel is deflected relatively far upward and in this manner can illuminate a building surface region located relatively far up on the vertical building wall 15. This light beam portion is illustrated by the arrow 20 in FIG. 1. The parabolic reflector section 22 thus substantially serves to direct indirect light up high. In this way, for example, a particularly high building wall, that is a wall extending high in the z-direction, can be illuminated all the way to its uppermost regions. If a light fixture 10 according to FIG. 2 is mounted in the ceiling, similarly a region relatively far down on a vertical building surface can be illuminated.

In general, it can be noted that by provision of the parabolic wall region 22 a building surface region that is far remote from the light fixture 10 can be illuminated.

At the same time, the arrangement of the elliptical wall region 21 enables the illumination of a building surface region close to the light fixture 10, relative to FIG. 1 a central region that is indicated for example by the arrow 19 in FIG. 1. Finally, the direct light, which is indicated by the beams 29a, 29b in FIG. 2 or by the arrow 18 in FIG. 1, can illuminate lower building surface regions, that is regions close to the light fixture.

It is noted that the observations above are illustrated in a very simplified manner for reasons of clarity. Overall, however, it can be stated that by using and mixing direct light and indirect light, where the indirect light is reflected on elliptically shaped reflector sections and on parabolic reflector sections, overall a particularly uniform light-intensity distribution can be achieved.

In this way, both building surface regions close to the light fixture and also building surface regions remote from the light fixture can be homogeneously illuminated.

To further illustrate the principle according to the invention, reference is made to FIGS. 4 and 5 that substantially correspond to the illustration in FIG. 1.

The hatched region indicated on the vertical building wall 15 is intended to represent a region to be illuminated by the light fixture 10. As is apparent from FIG. 4, the entire vertical building wall 15 is supposed to be illuminated substantially uniformly. Such a lighting situation is desired, for example, when paintings 35a, 35b in a museum are supposed to be illuminated.

By contrast, FIG. 5 shows an illumination situation on a vertical wall 15, where only an upper region of the wall is to be illuminated, for example because in the upper region of the vertical wall goods 36a, 36b are provided, for example on a shelf 37 that are supposed to be highlighted. Both illumination situations according to FIGS. 4 and 5 can be achieved using a light fixture 10, the light fixture to be used in each case comprising different reflector sections 21, 22.

FIG. 2 furthermore shows that in the light radiation direction, for example in the main radiation direction H, a dark-light reflector 26 is provided behind the spread lens 23. The dark-light reflector 26 shields an observer located approximately in the spatial angle region P at a shielding angle a. The shielding angle a can be 40°, for example. The dark-light reflector 26 ensures in a known manner than an observer located in the region P does not see any light beams reflected by the dark-light reflector 26.

Also for manufacturing reasons, in the example according to FIG. 2, a planar intermediate element 27 connects the elliptical wall region 21 to the parabolic wall region 22. The intermediate element preferably performs only a small or no lighting function and serves primarily for mechanically fastening the two cylindrical wall regions 21 and 22 to each other, particularly to increase their mechanical stability. The intermediate element 27 can also be made of a highly reflective material and may, under certain circumstances, contribute to conducting light.

Furthermore, the example according to FIG. 2 indicates a masking element 28 provided in the light radiation direction of the light source 12 in front of the parabolic wall region 22. The masking element 28 masks a small section of the parabolic wall region and can ensure that the light is directed as desired. In the example according to FIG. 2, the indicated light beam 30a extends through the masking element 28. This is supposed to illustrate that the masking element 28 may also be eliminated in one embodiment of the invention. If the masking element 28 is provided in the light path, it is preferably opaque.

The spread lens 23 is mounted transversely to the main radiation direction H of the light fixture 10. This means that the main radiation direction of the light fixture, the direction indicated at H, is substantially normal to the substantially planar spread lens. The spread lens is angled, particularly at a shielding angle a of 40°, at an angle to the vertical building surface 15 to be illuminated. The cover plate 25 of the light fixture is provided parallel to the floor surface 13 and is made particularly of clear glass. If the light fixture is an in-ground light fixture in accordance with FIG. 2, the cover plate 25 is aligned flush with the floor surface and in this way eliminates any edge that could be a tripping hazard. The cover plate can preferably also be walked on.

If the light fixture shown in FIG. 2 is a recessed light fixture or as a light fixture to be installed on the ceiling, the cover plate 25 may be completely eliminated under certain circumstances, so that the light-output opening 38 of the light fixture is completely open.

Based on FIGS. 6 to 17, a further example of an inventive light fixture 40 will be described hereinafter:

FIG. 6 shows an inventive light fixture 40 that is a recessed light fixture for installation in a ceiling 14. The light fixture 40 is used to illuminate a vertical wall 15, so that as in FIG. 1 the same building surface 15 is illuminated, however unlike FIG. 1 the light fixture 40 is installed in the ceiling.

It is noted that the inventive light fixture 40 can also be a surface-mounted ceiling light fixture or a spotlight, that is particularly that it can be installed displaceably on a spot carrier, for example mounted on a track.

The light fixture 40 according to FIG. 6 comprises a reflector 41, a lamp 42, a spread lens 43 and a dark-light reflector 46. A cover glass may also optionally be provided near the light-output opening 38 of the light fixture 40. With installation on the ceiling, however, the cover glass is usually not necessary.

The reflector element 41 is shown in FIG. 7 alone in a perspective oblique view and in FIG. 13 alone in a top view, approximately along the arrow XIII of FIG. 7. The reflector element comprises an inner surface 69 that is provided with a plurality of arcuate segments. The geometric shape of these segments will be explained below with reference to FIGS. 14 to 17.

The basic shape of the reflector element 41 is substantially parabolic in cross-section. This parabolic basic shape is apparent when viewing the cross-section of the reflector element 41 according to FIG. 6 from the left edge 46 according to FIG. 6 across the center apex region 44 to the right edge 45 according to FIG. 6. The focal point associated with the parabolic housing is indicate at F in FIG. 6. In this context, however, it is noted that FIG. 6 shows a reflector element 41 on a completely installed light fixture 40, where a reflector element 41 having originally a substantially rotation-symmetrical basic shape has already been severed or cut off.

The manufacturing method will also be described in detail hereinafter.

A lamp 42 is provided in or close to the focal point F of the parabolic basic shape of the reflector 41. In the embodiment according to FIG. 6, the lamp 42 is a metal-halide lamp. Such a metal-vapor lamp has a very small, almost punctiform shining spot, so that in this context it is also referred to as a punctiform light source.

The lamp 42 is fastened to a light fixture housing in a manner that is not shown. Also a reflector element 41 can also be fastened directly to the light fixture housing, optionally by using fastening elements cooperating with a lamp base 70. The light fixture housing is not shown in FIG. 6 for the sake of clarity. The electrical feed lines as well as optional electronic control lines for a ballast for the lamp 42 have also been eliminated from FIG. 6 for simplicity reasons.

The reflector element 41 has a basic shape that is substantially rotation-symmetrical about the center longitudinal axis 43 thereof. FIG. 14 shows the reflector element 41 according to FIG. 6 alone, directly after being manufactured. It is apparent to the observer that the reflector element 41 originally extends from the left edge 46a according to FIG. 14 via the apex region 44 to the right edge 45 according to FIG. 14. The reflector element 41 has been cut off or severed along a plane 53 after the manufacturing process. According to FIG. 6, the cut plane 53 extends in the example particularly at an angle 71 of approximately 70° relative to the center longitudinal axis 43 of the reflector 41.

A spread lens 23 is provided on the light fixture 40 along the cut plane 53 according to FIG. 6. The spread lens 23 corresponds to the spread lens discussed above for the embodiment according to FIG. 2 in terms of its function. Since as a result of such truncating of the reflector element 41, which originally was substantially rotation symmetrical about the center longitudinal axis 43 in terms of basic shape, now an oval light-output opening 24 exists on the reflector element 41. As is also apparent from the view of FIG. 9 in an exaggerated view, the spread lens 23 has an oval shape. The inside view according to FIG. 13 also shows the oval shape of the light-output opening 24 in a true-to-scale illustration.

As is best seen from the inside view of the reflector element 41 according to FIG. 13, the entire inner surface of the reflector element is divided into two partial regions 72 and 73. The two partial regions 72 and 73 are separated from each other along a boundary plane 51.

The segments of the partial region 72 primarily serve to imitate the reflection behavior of a reflector having an elliptical cross-section. The segments provided in the partial region 73 of the reflector 41 substantially serve to imitate the reflection behavior of a reflector having a parabolic cross-section.

In FIGS. 14 and 16, only the segments of the first partial region 72 are indicated and the segments of the second partial region 73 have been left out for the sake of clarity.

As is apparent from the view of FIG. 14, a plurality of segments extend from the apex region 44 to the right edge 45 of the reflector element 41 according to FIG. 14, where only the segments close to the edges 59a, 59b, 59c, 59d, 59e are referenced. The indicated light beams illustrate that the light beams starting from the light source in the focal point F are reflected on the segments and come together at a second focal point B located outside the light-output opening 24 of the reflector element 41.

The light that starts from the focal point F and does not impinge upon segments of the second partial region 73, the segments not being shown, can leave the reflector 41 as parallel beams.

FIG. 15 indicates that between every two segments of the first partial region 72 adjoining each other in the axial direction along the center longitudinal axis 43, for example between the adjoining segments 59b and 59c, also radial undercuts 60c may be provided. While the dotted lines in FIG. 15 indicate straight lines extending parallel to the center longitudinal axis 43 of the reflector element, the open spaces indicated at 60c, 60d, and 60e illustrate that radial undercuts may be provided between two respective adjoining segments 59b, 59c, 59d, 59e. Such radial undercuts are described in detail in the above-mentioned post-published German patent application DE 10 2007 035 528 by applicant, and this application is hereby included by reference for the purpose of avoiding repetitions to explanations provided there, also for the purpose of including individual characteristics.

It is noted that the provision of such radial undercuts is advantageous for the inventive light fixture, but not absolutely essential.

FIG. 15 furthermore illustrates that the surfaces of the segments 59b, 59c, 59d, 59e contributing to reflection are indicated at the reference numerals 61c, 61d, 61e. These cylindrical surfaces form the surfaces of this reflector section that in fact provide the lighting effect. On the other hand, the front surfaces facing the light-output opening 24, for example the surfaces 62d and 62e, have no lighting influence whatsoever on the reflection behavior of the reflector 41.

For simplicity reasons these front surfaces are indicated at reference numeral 62 in FIG. 13 and are shown as lightly shaded regions. These shaded regions extend in circles about the center longitudinal axis 43, however they vary in their shapes.

A comparison of the two partial regions 72 and 73 illustrates that in the partial regions completely different geometric structures are apparent, it being particularly evident that in the first partial region 72 larger surface portions on front surfaces are provided than in the partial region 73.

FIG. 16 illustrates a further aspect of an advantageous embodiment of the inventive light fixture: In this figure, segments 59aa, 59ab, 59ac, 59ad, 59ae, 59af, 59ag, 59ah, 59ai, 59aj, 59ak, 59al, 59am provided between the apex region 44 and the free edge 45 are shown schematically. FIG. 16 illustrates that at each segment a tangent is formed on an outer surface 74 of the reflector element 41. The tangents are indicated at 68ab, 68af, 68ai, and 68am in FIG. 16. Tangent 68ab is formed to the outer surface 74 of the reflector element 41 where segment 59ab is connected. Segment 59ab is cylindrical. FIG. 17 illustrates, by way of example based on a segment 59k, that each segment is formed by a cylindrical body having a basic radius r and the height l. The arcuate cylindrical surface 61k of this segment provides the actual reflection surface of the respective segment. The cylinder axis for the segment 59k is indicated at 66k in FIG. 17.

The cylinder axes of the segments 59ab, 59af, 59ai, and 59am are indicated in FIG. 16 with 66ab, 66af, 66ai, and 66am. Between the cylinder axes and the respective tangents, an angle of deviation 67ab, 67af, 67ai, and 67am is provided. This angle of deviation can vary with a spacing of the respective segment from the apex region 44.

In this way, it is possible to generate a reflection behavior as indicated in FIG. 14 and FIG. 6. The first partial region 72 of the reflector element 41 thus primarily serves to generate the reflection behavior of a reflector having an elliptical cross-section, so that the light beams come together in a focal point B. In FIG. 6, the light beams are indicated by way of example with 47a, 47b, 47c, and 47d and meet in a focal point B that is located approximately at a light-output opening 38 of the light fixture.

The light beams 48a, 48b, 48c emitted by the light source 42 according to FIG. 6 exit the light fixture 40 in a substantially parallel manner. If the light fixture 40 is installed in a ceiling, as is indicated for example in FIG. 6, the light beams reflected on the first region 72 primarily serve to illuminate a region of the building surface 15 to be illuminated that is close to the light fixture, while the light beams reflected on the second partial region 73 primarily serves to illuminate a region of the building surface 15 that is remote from the light fixture.

In this context it is noted that direct light is not shown in FIG. 6, but instead has been left out for the sake of clarity.

It shall also be noted that FIGS. 14 to 17 should be understood to serve only as examples and are provided for explaining the invention. According to the invention, also in the respective partial region 73 preferably a plurality of segments are provided that are formed by cylindrical bodies, as is shown for example in FIGS. 7 and 13.

FIG. 13 illustrates that the segments are provided in circular rows about the center longitudinal axis 43. The segments 63a, 63b, and 63c according to FIG. 13 are thus part of a common row. Columns extend transversely thereto. The segments 64a, 64b, and 64c according to FIG. 13 are part of a common column.

FIG. 13 furthermore illustrates that the partial region 72 comprises twice as many rows as the partial region 73. FIG. 13 also shows that the segments of two adjoining rows of segments in the partial region 72 are offset angularly by approximately half a column width.

FIG. 13 furthermore illustrates that the boundary plane 51 is substantially perpendicular to the largest cross-sectional area 52. FIG. 6 accordingly shows a view of the reflector element 41 along the largest cross-sectional area, that is approximately in a view direction of the plane VI-VI of FIG. 13.

FIG. 8 illustrates the principle of the light fixture 40 according to the invention: In the absence of a spread lens 23, it is possible through the inventive arrangement of segments in the interior of the reflector element 41 to achieve a light distribution having, for example, a substantially oval shape, which is indicated by the shape line 57 in FIG. 8, for example. In order to achieve a wide, uniform light distribution, a shape as that shown in dotted lines 58 in FIG. 8 can be achieved with the aid of the spread lens 23. It should be noted that the essential aspect is not to achieve a certain shape, but to illuminate the building surface to be illuminated particularly uniformly across the surface.

The diagrams according to FIGS. 11 and 12 that show the luminous intensity distributions in lines of equal luminous intensities, are better suited than the provision of shapes. FIG. 11 accordingly shows a shape 57 according to FIG. 8 of the light-intensity distribution on a wall 15 produced by means of a light fixture 40, where the spread lens 23 was eliminated. FIG. 12 shows the light-intensity distribution on the same wall with the aid of the spread lens 23. It is apparent from FIG. 12 that the light-intensity distribution is clearly broader and that the uniformity with respect to the light-intensity distribution from FIG. 6 without the spread lens is greater.

It should be noted that FIGS. 9 and 10 show a spread lens 23, where in principle a spread lens 23 can be used like that described above in the example according to FIGS. 1 to 5. It is essential for the invention that the spread lens is provided with lenses that ensure spreading of the light to help produce a more uniform illumination of the building wall. Preferably cylindrical lenses are mounted on at least one of the two faces of the spread lens 23. FIG. 10 illustrates such cylindrical lenses on the inner face, it being notable that the lenses can also be provided on the outer face or alternatively on both faces.

The axial orientation of the cylindrical lenses 34a, 34b, and 34c is such that they are extend parallel to the plane VI-VI from FIG. 13. In this way, the light is spread along the line indicated at reference numeral 51 in FIG. 13.

FIG. 8 illustrates that the vertical building wall 15 to be illuminated can be illuminated with the beams 54, 55, and 56 along the desired vertical height, the beams being intended to show the appropriate light. In accordance with the illustration according to FIGS. 4 and 5, the inventive light fixture 40, however, can also be used to illuminate any desired regions of the building surface 15 to be illuminated.

It should be noted that the inventive light fixture 40 preferably comprises a reflector element 41 that is provided on its interior entirely with segments, preferably entirely with cylindrical segments. The teaching according to the invention, however, also includes such light fixtures whose reflector element 41 is provided on its interior 69 with cylindrical segments only along an angular region about the center longitudinal axis 43, the remaining regions of the circumferential inner surface of the reflector element 41 being provided with differently shaped segments or left smooth.

Finally, the inventive light fixture also comprises a reflector element that is provided on its interior with spherically or aspherically arcuate segments. A key element of the invention in the subject matter of claim 20 is a combination of a spread lens with a faceted reflector divided into segments. An individual configuration of the reflection surface with the plurality of segments produces a radiation characteristic along a first direction and the use of a spread lens produces appropriate spreading in another direction.

With respect to the manufacture of a light fixture according to FIG. 6, it should be noted that the reflector element 41 is preferably made of press-formed aluminum. For this purpose, a circular aluminum disk blank can be used to produce, by pressing against a rotating male mold, a dished reflector element that is substantially rotation-symmetrical in its basic shape. The male mold, which is not shown, is provided with appropriate formations on the outer surface, where these outer formations can be embossed or pressed into the interior of the reflector element 41. Removal of the mold from the reflector element is possible in the axial direction. When providing undercuts, as is indicated in FIG. 15, preferably also a multi-part tools can be used that is described in the abovementioned post-published patent application by the applicant.

After removing the mold from the reflector element, the element can be cut along the plane 53. Starting from FIG. 14, severing by means of sawing or slicing, for example, is performed such that a cutting tool is displaced relative to the fixed reflector element 41 along the plane 53. The region between the original free edge 46a and the new edge 46 after severing the separating piece 75, that is the separating piece 75, is removed and is scrapped.

The resultant reflector element 41 comprising the now oval light-output opening 24 can be installed in the light fixture 40 and has a particularly compact design. In a particularly advantageous embodiment, the center longitudinal axis 43 of the reflector element 41 extends at an angle to the ceiling 14 in the installed state of the light fixture 40.

FIG. 6 furthermore shows a dark-light reflector section 26 that enables shielding at a shielding angle of approximately 40°.

With respect to the principle of dark-light reflector technology, reference is made to published prior art by the applicant and the knowledge of the person skilled in the art. The dark-light reflector section 26 makes it possible to prevent glare for an observer located in the angular space P with the angle α by light beams reflected on the reflector 26.

For a better understanding of the geometric design of the reflector, it should be noted that the boundary plane 51 extends between the partial regions 72 and 73 when viewing FIG. 6 along the center longitudinal axis 43 of the reflector element 41. The cut plane 53 intersects the boundary plane 51 along a straight line indicated at reference numeral 76. This straight line extends perpendicular to the paper plane according to FIG. 6 and hence perpendicular to the center longitudinal axis 43 of the reflector element.

In the two examples according to FIGS. 2 and 6, in the installed state of the light fixture, the spread lens 23 is angled at an acute angle relative to the wall to be illuminated, preferably at an angle of approximately 50°. The spread lens 23 can furthermore also preferably be angled at an angle ranging between 20° and 70° relative to the wall to be illuminated.

1. A light fixture for illuminating a building surface, comprising a dished housing having a light-output opening, a light source being provided on the interior of the housing, indirect light starting from the light source passing through the light-output opening only after being reflected on reflector surfaces and direct light starting from the light source passing through without reflection on reflector surfaces, a spread lens being provided that is at the light-output opening and that ensures that the light is spread in order to make illumination of the building surface more even, the reflector surfaces each comprising a wall region with a parabolic cross-section and a wall region with an elliptical cross-section.

2. The light fixture according to claim 1 wherein the housing has a trough shape.

3. The light fixture according to claim 2 wherein the light source is axially elongated.

4. The light fixture according to claim 2 wherein the spread lens ensures a spreading of the light in the axial direction.

5. The light fixture according to claim 2 wherein the housing and/or the wall regions are cylindrical.

6. The light fixture according to claim 2 wherein the spread lens comprises a plurality of ribs extending transversely to the axial dimension to form cylindrical lenses.

7. The A light fixture according to any claim 1 wherein a metal halide lamp, particularly an HID lamp, or a low-voltage halogen incandescent lamp, is provided as the light source.

8. The A light fixture according to any claim 1 wherein the wall regions are made of metal, particularly of aluminum, and in particular are highly reflective.

9. The light fixture according to any claim 1 wherein the light fixture is a wallwasher.

10. The light fixture according to any claim 1 wherein the light fixture is an in-ground light fixture.

11. The light fixture according to any claim 1 wherein the light source is provided at the focal point or close to the focal point of the elliptical wall region and in the focal point or close to the focal point of the parabolic wall region.

12. The light fixture according to any claim 1 wherein the light fixture uniformly illuminates the building surface.

13. The light fixture according to any claim 1 wherein the elliptical wall region extends approximately across a 205° angle region around the light source.

14. The light fixture according to any claim 1 wherein the parabolic wall region extends approximately across a 45° angle region around the light source.

15. The light fixture according to any claim 1 wherein the parabolic wall region is mounted relative to the light source such that the light reflected thereon primarily illuminate a region of the building surface that is remote from the light fixture and/or that the elliptical wall region is mounted relative to the light source such that the light reflected thereon primarily illuminate a region of the building surface that is close to the light fixture.

16. The light fixture according to any claim 1 wherein the spread lens is oriented substantially transversely to a main radiation direction of the light fixture and particularly at an angle to the wall to be illuminated.

17. The light fixture according to any claim 1 wherein the light fixture comprises a dark-light reflector section in the light radiation direction behind the spread lens.

18. The light fixture according to any claim 1 wherein the elliptical wall region and the parabolic wall region are connected by means of a particularly planar intermediate element.

19. The light fixture according to any claim 1 wherein in the light radiation direction of the light source a masking element is provided in front of the parabolic wall region.

20. A light fixture for illuminating building surfaces, comprising a substantially dished reflector element extending along a center longitudinal axis from an apex region to a light-output opening, at least one lamp being provided in the interior of the element, indirect light starting from the light source only passing through the light-output opening after having been reflected on the inner surface of the reflector element and direct light starting from the light source pass through without reflection on the inner surface of the reflector element, a spread lens being provided that is in the region of the light-output opening and that ensures spreading of the light to help produce a more uniform illumination of the building surface, a plurality of segments comprising surfaces arcuate inwardly being provided on the inner surface of the reflector element.

21. The light fixture according to claim 20 wherein the reflector element is made of metal.

22. The light fixture according to claim 21 wherein the reflector element is made of press-formed aluminum.

23. The light fixture according to claim 20 wherein the reflector element comprises a housing that is rotation symmetrical about the center longitudinal axis with respect to its basic shape, the housing being cut off or severed at the light-output opening along a plane at an angle to the center longitudinal axis or comprising an edge surrounding the light-output opening, the edge extending along a plane oriented at an angle to the center longitudinal axis of the reflector element.

24. The light fixture according to claim 23 wherein the spread lens lies on the plane or cut plane relative to the reflector element.

25. The light fixture according to claim 20 wherein at least some segments are each formed by a section of a cylinder, particularly a circular cylindrical body.

26. The light fixture according to claim 20 wherein all segments are each formed by a section of a cylinder, particularly a circular cylindrical body.

27. The light fixture according to claim 25 wherein the center line of the cylinder is oriented substantially parallel to the center longitudinal axis of the reflector element or angled to the same at an angle of less than 45°.

28. The light fixture according to claim 25 wherein the inclination of the center lines of the cylinders, particularly the inclination thereof relative to a tangent that can be placed on the outer surface of the reflector element, varies as a function of spacing of the cylinder from the apex of the reflector.

29. The light fixture according to claim 28 wherein the variation of the inclination of the cylinder axes of at least several segments of an angularly extending region is selected such that the light beams emitted by the light source and impinging upon these cylindrical segments intersect in a focal point.

30. The light fixture according to claim 29 wherein the focal point is located outside of the light-output opening of the reflector element.

31. The light fixture according to claim 30 wherein the focal point is located close to or in the light-output opening of the light fixture.

32. The light fixture according to claim 25 wherein the cylinder axes of a plurality of cylinders having the same distance to the apex region of the reflector element have the same inclination to the center longitudinal axis of the reflector element.

33. The light fixture according to any claim 20 wherein the inner surface of the reflector element is provided with segments along the entire circumference.

34. The light fixture according to claim 33 wherein the inner surface of the reflector element is divided into at least two partial regions.

35. The light fixture according to claim 34 wherein in the different partial regions differently arcuate and/or differently sized segments are provided or a varying areal density of segments exists.

36. The light fixture according to claim 20 wherein the segments are oriented in rows extending in circles about the center longitudinal axis of the reflector element and along columns extending transversely thereto.

37. The light fixture according to claim 34 wherein the different partial regions are associated with different row numbers.

38. The light fixture according to claim 34 wherein the cylindrical elements within a partial region are identical in size.

39. The light fixture according to claim 34 wherein the reflector element comprises two partial regions that each take up an angularly extending region of approximately 180°.

40. The light fixture according to claim 34 wherein in the second partial region segments are provided that primarily or at least partly imitate a reflection behavior of a reflector having a parabolic cross-section.

41. The light fixture according to claim 40 wherein in the first partial region segments are provided that primarily or at least partly imitate a reflection behavior of a reflector having an elliptical cross-section.

42. The light fixture according to claim 34 wherein the first partial region and the second partial region are separated by a boundary plane.

43. The light fixture according to claim 23 wherein the boundary plane and the cut plane intersect along a straight line that extends perpendicular to the center longitudinal axis.

44. The light fixture according to claim 20 wherein, when viewing a largest cross-sectional area of the reflector element, a plurality of segments of a first type are provided on the first side of the center longitudinal axis of the reflector element and a plurality of segments of a second type are provided on the other side of the center longitudinal axis.

45. The light fixture according to claim 20 wherein, when viewing a cross-sectional area that is oriented perpendicular to the largest cross-sectional area, a symmetrical shape of the reflector element relative to the center longitudinal axis is apparent.

46. The light fixture according to claim 44 wherein the segments of a first type primarily imitate a reflection behavior of a reflector having an elliptical cross-section.

47. The light fixture according to claim 20 wherein the segments of a second type primarily imitate a reflection behavior of a reflector having a parabolic cross-section.

48. The light fixture according to claim 20 wherein the light source is a substantially punctiform source.

49. The light fixture according to claim 48 wherein a metal halide lamp, particularly an HID lamp, or a low-voltage halogen incandescent lamp, or at least an LED, is provided as the light source.

50. The light fixture according to claim 20 wherein the spread lens ensures a spreading of the light in a direction transversely to the largest cross-sectional area.

51. The light fixture according to claim 20 wherein the spread lens comprises a plurality of ribs to form cylindrical lenses, the ribs extending along a direction parallel to the largest cross-sectional area.

52. The light fixture according to claim 50 wherein the light fixture is a wallwasher.

53. The light fixture according to claim 20 wherein the light fixture is a recessed light fixture or as a spotlight to be mounted on the ceiling.

54. The light fixture according to claim 20 wherein the light fixture uniformly illuminates the building surface.

55. The light fixture according to claim 20 wherein the light source is located in the focal point or close to the focal point of a parabolic housing of the reflector element.

56. The light fixture according to claim 20 wherein a partial region of the reflector for imitating a light distribution of a parabolic reflector is oriented relative to the light source such that the light reflected thereon primarily illuminate a region of the building surface that is remote from the light fixture and/or that a partial region of the reflector for imitating a light distribution of a reflector having an elliptical cross-section is oriented relative to the light source such that the light reflected thereon primarily illuminate a region of the building surface that is close to the light fixture.

57. The light fixture according to claim 20 wherein the spread lens is oriented substantially transversely to a main radiation direction of the light fixture and at an angle to the wall to be illuminated.

58. The light fixture according to any claim 20 wherein the light fixture comprises a dark-light reflector section in the light radiation direction behind the spread lens.

59. A method for producing a reflector element from a starting material workpiece, particularly aluminum, comprising a plurality of segments on the inner surface, characterized by the following steps:
a) providing a starting material workpiece, particularly a circular aluminum blank,
b) applying a relative force between the workpiece and a male mold, the male mold having an outer shape that is impressed into the inner shape of the workpiece,
c) performing an axial displacement of the male mold relative to the workpiece to remove the male mold from the reflector element,
d) severing a section of the reflector element along a separation plane that is angled relative to a center longitudinal axis of the reflector element.

60. A light fixture for illuminating building surfaces, the fixture comprising
a substantially dished first reflector element and flaring along a center longitudinal axis from an apex region toward a light-output opening,
at least one lamp provided in an interior of the element,
a spread lens provided in the region of the light-output opening to ensure spreading of the light to help produce a more uniform illumination of the building surface, the first reflector element being provided with a plurality of segments having an inwardly arcuate surface, the segments being provided on the inner surface, the reflector element comprising a housing rotational symmetrical about the central longitudinal axis with respect to the basic shape, the housing being cut off or severed at the light-output opening thereof along a plane at an angle to the center longitudinal axis, or comprising an edge surrounding the light-output opening, the edge extending along a plane that is oriented an acute angle to the center longitudinal axis of the reflector element, the first reflector element being replaced with a second reflector element having the same outer dimensions, the second reflector element therein comprising a plurality of segments having an inwardly arcuate surface, the types of the segments or the shape of the segments or the curvatures of the segments being selected differently in order to achieve a light radiation characteristic that differs from that of the first reflector element.
